(19) United States
(12) Patent Application Publication
(10) Pub. No.: US 2026/0118489 A1
(43) Pub. Date: Apr. 30, 2026

(54) OBJECT DETECTION DEVICE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: TAKAHIRO HIGUCHI, Nisshin-shi (JP); KAZUYA MIURA, Nisshin-shi (JP); KOICHI OYAMA, Nisshin-shi (JP)

(21) Appl. No.: 19/364,167

(22) Filed: Oct. 21, 2025

(30) Foreign Application Priority Data
Oct. 29, 2024 (JP) 2024-189860

(51) Int. Cl. G01S 7/486; G01S 7/48; G01S 17/32

(52) U.S. Cl. CPC G01S 7/4868; G01S 7/4802; G01S 17/32

(57) ABSTRACT

An object detection device includes a light source, an optical output module, a detector, a highly reflective object determiner, an intensity adjuster, and a remeasurement controller. The optical output module is configured to output a beam formed from a light generated by the light source to scan a measurement range. The detector is configured to measure a distance to an object using a signal obtained by photoelectrically converting a reflected light that is reflected by the object. The remeasurement controller is configured to, when the highly reflective object determiner determines that a signal obtained by photoelectrically converting the reflected light received from a certain direction exceeds a dynamic range of the detector, control the optical output module to output a low-intensity beam, whose intensity has been reduced by the intensity adjuster, toward the certain direction to perform a remeasurement.

### CROSS REFERENCE TO RELATED APPLICATION

The present application claims the benefit of priority from Japanese Patent Application No. 2024-189860 filed on Oct. 29, 2024. The entire disclosure of the above application is incorporated herein by reference.

### TECHNICAL FIELD

The present disclosure relates to an object detection device that detects objects.

### BACKGROUND

Conventionally, as object detection devices for detecting objects, for example, LiDAR is known. LiDAR is an abbreviation for Light Detection and Ranging, or Laser Imaging Detection and Ranging. The object detection device treats a measurement range from a measurement start direction to a measurement end direction as a frame, repeatedly scans the frame with a beam, and receives and analyzes reflected light reflected from an object present within the measurement range, thereby measuring parameters such as a direction and a distance of the object.

### SUMMARY

An object detection device according to an aspect of the present disclosure is configured to detect an object, and includes a light source, an optical output module, a detector, a highly reflective object determiner. The light source is configured to generate a light. The optical output module is configured to output a beam formed from the light generated by the light source to scan a measurement range. The detector is configured to measure a distance to the object using a signal obtained by photoelectrically converting a reflected light that is reflected by the object. The highly reflective object determiner is configured to determine whether the signal obtained by photoelectrically converting the reflected light exceeds a dynamic range of the detector. The object detection device may further include an intensity adjuster and a remeasurement controller. The intensity adjuster may be configured to adjust an intensity of the beam formed from the light generated by the light source. The remeasurement controller may be configured to, when the highly reflective object determiner determines that the signal obtained by photoelectrically converting the reflected light received from a certain direction exceeds the dynamic range of the detector, control the optical output module to output a low-intensity beam, whose intensity has been reduced by the intensity adjuster, toward the certain direction to perform a remeasurement.

### BRIEF DESCRIPTION OF DRAWINGS

Objects, features and advantages of the present disclosure will become apparent from the following detailed description made with reference to the accompanying drawings. In the drawings:

FIG. 1 is a schematic configuration diagram of an object detection device according to a first embodiment;

FIG. 2 is a schematic configuration diagram of an optical IC included in the object detection device according to the first embodiment;

FIG. 3 is an explanatory diagram for illustrating measurement within one frame by the object detection device according to the first embodiment;

FIG. 4 is an explanatory diagram, following FIG. 3, for illustrating measurement within the one frame;

FIG. 5 is a flowchart for illustrating a control process of measurement by the object detection device according to the first embodiment;

FIG. 6 is a table for illustrating the control process of measurement by the object detection device according to the first embodiment;

FIG. 7 is a table for illustrating a control process of measurement by an object detection device of a comparative example;

FIG. 8 is an explanatory diagram for illustrating measurement within one frame by the object detection device of the comparative example;

FIG. 9 is an explanatory diagram for illustrating measurement within one frame by the object detection device according to the first embodiment, in a case where a highly reflective object different from that in FIG. 3 is present;

FIG. 10 is a flowchart for illustrating a control process of measurement by an object detection device according to a second embodiment;

FIG. 11 is an explanatory diagram for illustrating measurement within one frame by the object detection device according to the second embodiment;

FIG. 12 is an explanatory diagram, following FIG. 11, for illustrating measurement within the one frame;

FIG. 13 is an explanatory diagram for illustrating measurement within one frame in a modification of the second embodiment;

FIG. 14 is an explanatory diagram, following FIG. 13, for illustrating measurement within the one frame;

FIG. 15 is a table for illustrating a control process of measurement by an object detection device according to a third embodiment;

FIG. 16 is a table for illustrating a control process of measurement by an object detection device according to a fourth embodiment;

FIG. 17 is a table for illustrating a control process of measurement by an object detection device according to a fifth embodiment;

FIG. 18 is an explanatory diagram for illustrating measurement within one frame by an object detection device according to a sixth embodiment;

FIG. 19 is an explanatory diagram for illustrating measurement within one frame by an object detection device according to a seventh embodiment; and

FIG. 20 is an explanatory diagram for illustrating measurement within one frame by an object detection device according to an eighth embodiment.

### DETAILED DESCRIPTION

A LiDAR may be configured such that, when receiving reflected light from a highly reflective object such as a retroreflector from a certain direction, the LiDAR stops outputting a beam toward that certain direction when scanning a next frame. In this case, the LiDAR can prevent the reflected light received during the scan of the next frame from becoming saturated and turning into noise. The LiDAR may include, in addition to a primary light emitter for detecting objects (that is, a light source of a main system), a secondary light emitter (that is, a light source of another system) and elements such as a diffuser lens.

However, if the LiDAR stops outputting the beam toward the certain direction where the highly reflective object is present, the LiDAR cannot measure a distance to the highly reflective object. In addition, if the light source is turned off when stopping beam output, a certain recovery time is required to turn the light source back on. Furthermore, if the secondary light emitter and the diffuser lens are added in addition to the primary light emitter for detecting objects, the number of components and costs increase.

An object detection device according to an aspect of the present disclosure is configured to detect an object, and includes a light source, an optical output module, a detector, a highly reflective object determiner, an intensity adjuster, and a remeasurement controller. The light source is configured to generate a light. The optical output module is configured to output a beam formed from the light generated by the light source to scan a measurement range. The detector is configured to measure a distance to the object using a signal obtained by photoelectrically converting a reflected light that is reflected by the object. The highly reflective object determiner is configured to determine whether the signal obtained by photoelectrically converting the reflected light exceeds a dynamic range of the detector. The intensity adjuster is configured to adjust an intensity of the beam formed from the light generated by the light source. The remeasurement controller is configured to, when the highly reflective object determiner determines that the signal obtained by photoelectrically converting the reflected light received from a certain direction exceeds the dynamic range of the detector, control the optical output module to output a low-intensity beam, whose intensity has been reduced by the intensity adjuster, toward the certain direction to perform a remeasurement.

According to this configuration, in the remeasurement, the optical output module outputs the low-intensity beam in the certain direction to perform the remeasurement. Therefore, in the remeasurement, it is possible to prevent the signal obtained by photoelectrically converting the reflected light from the certain direction from exceeding the dynamic range of the detector. Accordingly, the object detection device is capable of measuring the distance to highly reflective objects that reflect strong reflected light. In addition, since the object detection device forms the low-intensity beam using the intensity adjuster with light generated from the identical light source, the light source remains in the ON state. Since the light source is not turned OFF, no recovery time for the light source is required. Accordingly, this object detection device can improve the measurement rate (that is, the speed and frequency of distance measurement).

Furthermore, since the intensity adjuster forms the low-intensity beam using light generated from the identical light source, there is no need to add a separate light source or the like. Accordingly, the object detection device can reduce the number of components and costs.

Embodiments of the present disclosure will now be described with reference to the drawings. In the following embodiments, the same or equivalent parts are denoted by the same reference numerals, and their descriptions will be omitted.

### First Embodiment

As an object detection device according to a first embodiment, a LiDAR device mounted on a vehicle, for example, will be described. The LiDAR is a sensor that outputs an infrared beam and measures parameters such as a direction and a distance of an object based on a reflected light from the object. The LiDAR is also referred to as a laser radar. The object detection device according to the first embodiment is capable of detecting various objects such as vehicles and pedestrians, as well as highly reflective objects such as retroreflectors. Here, a highly reflective object refers to an object that reflects light with high intensity.

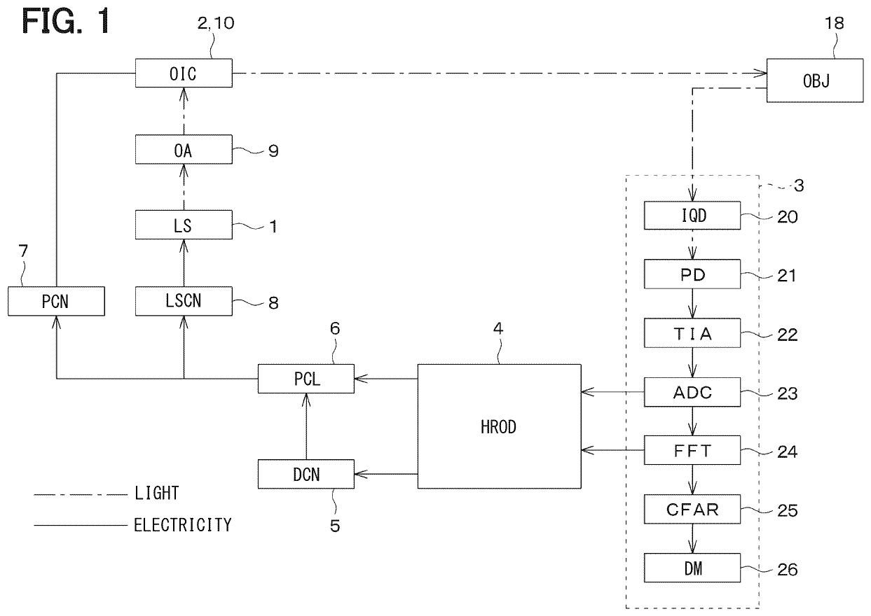

As shown in FIG. 1, the object detection device includes a light source (LS) 1, an optical integrated circuit (OIC) 2, a detector (DET) 3, a highly reflective object determiner (HROD) 4, a direction controller (DCN) 5, a phase calculator (PCL) 6, and a phase controller (PCN) 7, and the like. Hereinafter, the optical integrated circuit 2 is referred to as “optical IC 2.” The optical IC 2 serves as an “optical output module” that outputs a beam. In addition, the optical IC 2 and the phase controller 7 together serve as an “intensity adjuster” that adjusts the intensity of the beam. The direction controller 5 and the phase calculator 6 together serve as a “remeasurement controller” that controls remeasurement of highly reflective objects.

The light source 1 is controlled by a light source controller (LSCN) 8, and generates a light (for example, an infrared light) using a frequency-modulated continuous wave (FMCW) method. The FMCW method is a method in which a light whose frequency is modulated to increase over time (that is, chirp) is output. The light generated by the light source 1 is amplified by the optical amplifier (OA) 9 and enters the optical IC 2.

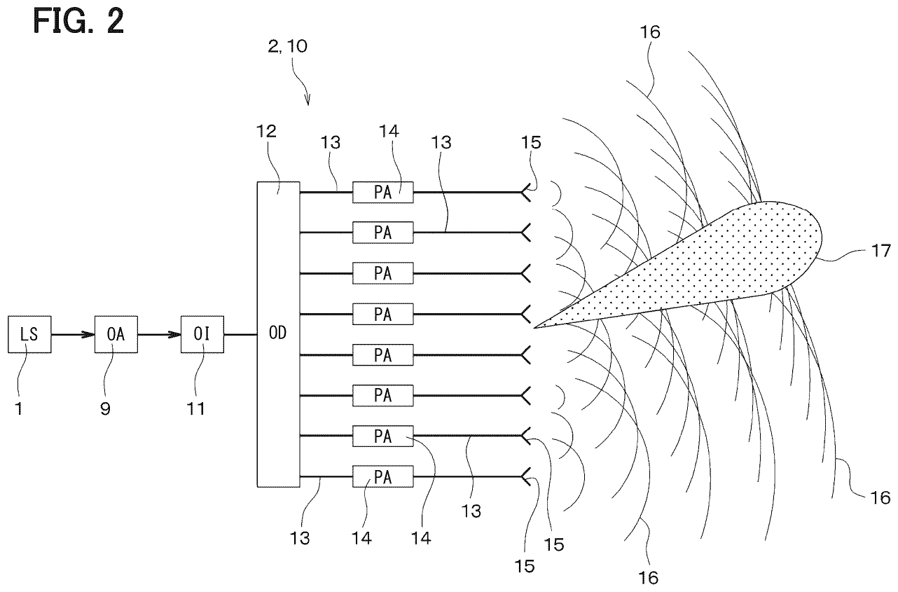

As shown in FIG. 2, the optical IC 2 constitutes an optical phased array 10 (hereinafter referred to as “OPA 10”). The OPA 10 is a device capable of freely controlling a direction and a shape of the beam output from the optical IC 2 without using mechanical components such as movable mirrors.

The OPA 10 includes an optical input (OI) 11, an optical distributor (OD) 12, a plurality of optical waveguides 13, a plurality of phase adjusters (PA) 14, and a plurality of optical antennas 15. The OPA 10 is formed on a silicon substrate (not shown). The light from the light source 1 is incident on the optical input 11 via the optical amplifier 9. The optical distributor 12 distributes the light incident on the optical input 11 to the plurality of optical waveguides 13 arranged in an array. The plurality of optical waveguides 13 guide the light distributed by the optical distributor 12 to the plurality of optical antennas 15 provided at respective tips of the optical waveguides 13. The plurality of phase adjusters 14 disposed at intermediate positions of the respective optical waveguides 13 control the phase of the light passing through the respective optical waveguides 13 by changing the refractive index of the optical waveguides 13. The light is output from the plurality of optical antennas 15. The OPA 10 can output a beam 17 in any desired direction by controlling the phase of the light passing through the plurality of optical waveguides 13 using the phase adjusters 14, by utilizing the diffraction and interference of the light waves 16 output from the plurality of optical antennas 15. The OPA 10 serves as the “optical output module” and outputs the beam 17 to scan a certain measurement range outside the vehicle.

The phase controller 7 shown in FIG. 1 controls the driving of the phase adjusters 14 included in the OPA 10. The phase controller 7 and the OPA 10 operate as an “intensity adjuster” and are capable of adjusting the direction and the intensity of the beam formed based on the light generated from the light source 1. Specifically, the phase controller 7 controls the driving of the phase adjusters 14 of the OPA 10, and by controlling the phase of the light passing through the plurality of optical waveguides 13, an area perpendicular to a propagation direction of the beam (that is, a beam diameter) can be broadened in any direction and to any size, thereby diffusing the beam and reducing the beam intensity per unit volume. More specifically, the phase controller 7 and the OPA 10 can broaden the beam diameter and diffuse the beam by phase control including non-linearization or randomization of the phase shift amount, thereby reducing the beam intensity per unit volume. Hereinafter, a beam whose intensity is reduced compared to a beam formed in normal measurement (that is, a reference beam) will be referred to as a “low-intensity beam.” In addition, the amount by which the intensity of the low-intensity beam is reduced relative to the intensity of the beam formed during normal measurement (that is, the reference beam) is referred to as “intensity reduction amount.”

As shown in FIG. 1, the beam output from the optical IC 2 is reflected by an object (OBJ) 18 and enters the detector 3 of the object detection device as reflected light. The detector 3 includes, for example, an IQ detector (IQD) 20, a photodiode (PD) 21, a transimpedance amplifier (TIA) 22, an analog-to-digital converter (ADC) 23, a fast Fourier transform section (FFT) 24, a constant false alarm rate (CFAR) 25, and a distance meter (DM) 26.

The reflected light entering the detector 3 undergoes IQ detection (that is, quadrature detection) processing and is then photoelectrically converted by the photodiode 21. The photoelectrically converted electrical signal passes through the transimpedance amplifier 22 and is converted into a digital electrical signal by the ADC 23. The digital electrical signal is then subjected to frequency analysis by the FFT 24. The frequency-analyzed information is processed by the CFAR 25, which extracts a peak value. The information regarding the peak value is input to the distance meter 26. The distance meter 26 measures the distance to the object 18 based on the peak value. It should be noted that if the electrical signal obtained by photoelectrically converting the reflected light from the object 18 exceeds the dynamic range of the detector 3, the detector 3 cannot perform distance measurement for the object 18.

The digital electrical signal obtained by analog-to-digital conversion in the ADC 23, as well as the frequency-analyzed information from the FFT 24, is also input to the highly reflective object determiner 4. The highly reflective object determiner 4 determines whether the electrical signal, obtained by photoelectrically converting reflected light received from a certain direction, exceeds the dynamic range of the detector 3, based on information such as the peak intensity of the signal or the frequency width of the signal (for example, full width at half maximum). This determination serves to determine whether a highly reflective object that generates such reflected light is present in the certain direction within the measurement range. The highly reflective object determiner 4 is implemented, for example, by a comparator. When the highly reflective object determiner 4 determines that the signal obtained by photoelectrically converting the reflected light received from the certain direction exceeds the dynamic range of the detector 3 (in other words, when it is determined that a highly reflective object is present in the certain direction), that information is transmitted to the direction controller 5 and the phase calculator 6.

Upon receiving the above information from the highly reflective object determiner 4, the direction controller 5 and the phase calculator 6 execute a control process for remeasurement of the highly reflective object present in the certain direction. The direction controller 5 transmits a command signal to the phase calculator 6 for remeasuring the direction where the highly reflective object is present by outputting a low-intensity beam toward that direction from the optical IC 2. The phase calculator 6 performs phase calculations for the direction where the highly reflective object is present, as well as phase calculations necessary to achieve the “intensity reduction amount” of the low-intensity beam, so that the optical IC 2 outputs the low-intensity beam toward the direction of the highly reflective object. The intensity reduction amount is calculated based on the reflected light received from the certain direction in the previous measurement, such that the electrical signal obtained by photoelectrically converting the reflected light reflected in the certain direction falls within the dynamic range of the detector 3.

The calculation results from the phase calculator 6 are transmitted to the light source controller 8 and the phase controller 7. The light source controller 8 controls the driving of the light source 1. The phase controller 7 controls the driving of the phase adjusters 14 included in the optical IC 2, so that the optical IC 2 outputs the low-intensity beam with the intensity reduction amount calculated by the phase calculator 6 toward the certain direction (that is, the direction where the highly reflective object is present) to perform remeasurement of the highly reflective object 19.

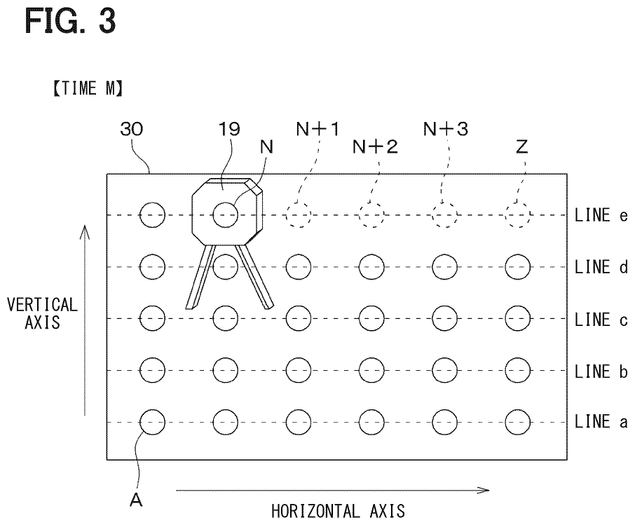

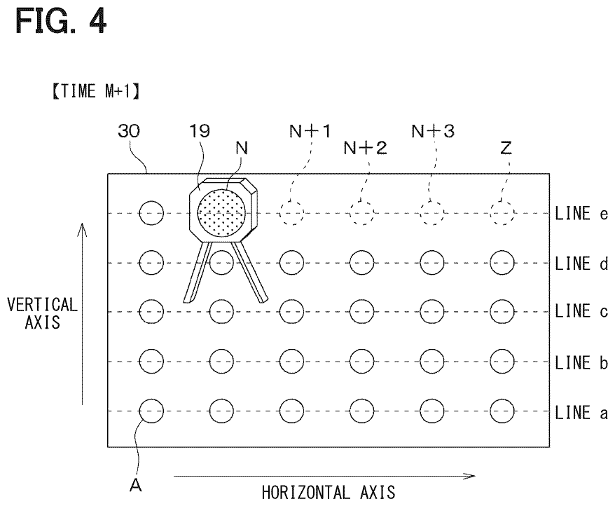

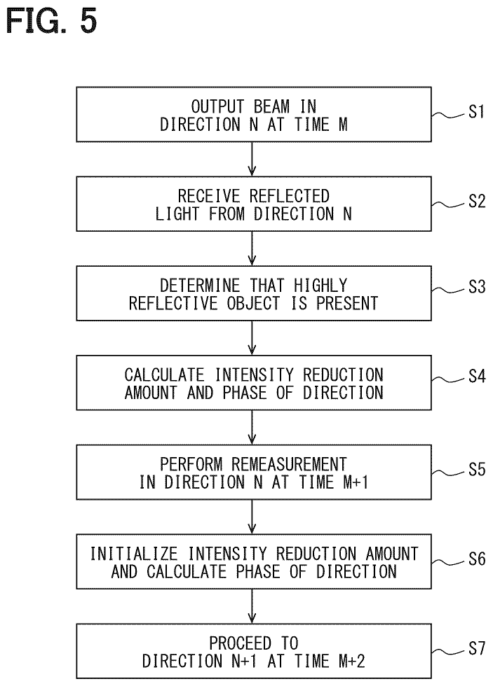

Next, a control process by which the object detection device of the first embodiment performs remeasurement of a highly reflective object will be described with reference to the explanatory diagrams in FIGS. 3 and 4 and the flowchart in FIG. 5.

This control process is assumed to be executed while the vehicle equipped with the object detection device is in operation. In the flowchart of FIG. 5 and its description, steps will simply be denoted as “S.” This also applies to the control process described in a comparative example and in each embodiment discussed below.

As shown in FIG. 3, a single scan by the object detection device of a measurement range 30 from a measurement start direction A to a measurement end direction Z is referred to as one frame. In addition, a scan by the object detection device in the same straight or curved direction within one frame is referred to as one scan line. For convenience of explanation, FIG. 3 shows five scan lines within one frame, and these are referred to sequentially as line a to line e in the vertical direction of FIG. 3 (that is, from the bottom to the top of FIG. 3).

The object detection device, for example, performs measurement by scanning horizontally from the leftmost direction of line a as the measurement start direction A of one frame, then the object detection device similarly scans and measures each scan line in order from line a to line e, and sets the rightmost direction of line e as the measurement end direction Z of the one frame. FIG. 3 shows a state in which the object detection device is in the process of scanning from the measurement start direction A to the measurement end direction Z of the one frame. Specifically, FIG. 3 shows a state in which the object detection device, after sequentially measuring line a to line d from the measurement start direction A, is performing measurement in direction N on line e. It is assumed that a highly reflective object 19 is present in direction N. At the time shown in FIG. 3, the measurements for directions N+1, N+2, N+3, and the measurement end direction Z have not yet been performed, and these directions are indicated by dashed lines.

The flowchart of FIG. 5 illustrates a control process for measurement from direction N to direction N+1. As shown in FIG. 5, in S1, the object detection device outputs a beam toward direction N at time M. In S2, the object detection device receives a reflected light from the beam output at time M and reflected by the highly reflective object 19 present in direction N. Then, in S3, the object detection device determines, by means of the highly reflective object determiner 4, whether the signal obtained by photoelectrically converting the reflected light exceeds the dynamic range of the detector 3. In S3, it is assumed that the highly reflective object determiner 4 determines that the signal obtained by photoelectrically converting the reflected light received from direction N exceeds the dynamic range of the detector 3. That is, as shown in FIG. 3, it is determined that the highly reflective object 19 is present in direction N. Then, in S4 of FIG. 5, the object detection device, by means of the direction controller 5 and the phase calculator 6, calculates the intensity reduction amount for the low-intensity beam to be output in the remeasurement, as well as the phase of the direction in which the highly reflective object 19 is present.

Subsequently, in S5, the object detection device outputs the low-intensity beam toward direction N at time M+1 to perform remeasurement in direction N. That is, as shown in FIG. 4, the low-intensity beam is output toward the highly reflective object 19 present in direction N. Then, the object detection device receives a reflected light from the low-intensity beam output at time M+1 and reflected in direction N, and measures the distance to the highly reflective object 19 present in direction N.

Thereafter, in S6, the object detection device initializes the intensity reduction amount (that is, returns the beam intensity to the reference beam intensity), and calculates the phase for the direction in which the beam will be output in the next measurement (that is, direction N+1). Then, in S7, the object detection device outputs a beam toward direction N+1 at time M+2 to perform measurement in direction N+1.

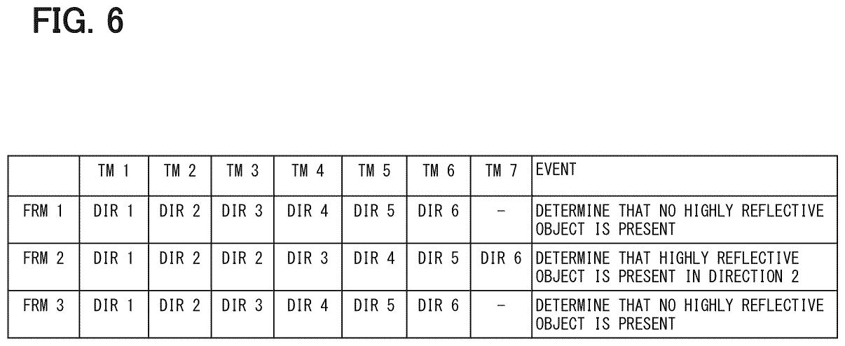

Next, a control process for measurement by the object detection device according to the first embodiment will be explained with reference to the table in FIG. 6. The table in FIG. 6 shows, with the vertical axis representing “frames (FRM)” and the horizontal axis representing “times (TM),” directions (DIR) to be measured at each time in each frame. For the sake of convenience in explanation, only directions 1 to 6 on one line among the plurality of lines are shown for each frame. In addition, times 1 to 7 are different points in time within each frame.

As shown in FIG. 6, during the scanning of frame 1, the object detection device measures directions 1 to 6 at times 1 to 6.

Next, during the scanning of frame 2, the object detection device measures direction 1 at time 1 and measures direction 2 at time 2. At this time, if the object detection device determines that a highly reflective object 19 is present in direction 2 at time 2, the object detection device outputs a low-intensity beam toward direction 2 again at time 3, which is the next time, to perform remeasurement in direction 2. If a distance to the highly reflective object 19 present in direction 2 can be measured in the remeasurement, directions 3 to 6 are measured at times 4 to 7.

Subsequently, during the scanning of frame 3, the object detection device measures directions 1 to 6 at times 1 to 6. It is assumed that, due to the movement of the vehicle equipped with the object detection device or the movement of the highly reflective object 19, the highly reflective object 19 is not detected during the scanning of frame 3.

As described above, the object detection device of the first embodiment quickly performs a remeasurement after determining the presence of the highly reflective object 19, enabling faster distance measurement of the highly reflective object 19 and improving the distance measurement rate. In addition, since the object detection device of the first embodiment can adjust the intensity reduction amount by phase control of the OPA 10, the object detection device does not require additional components and does not require any recovery time.

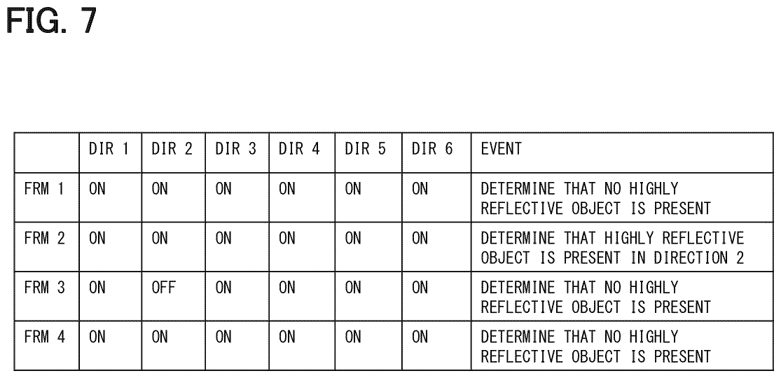

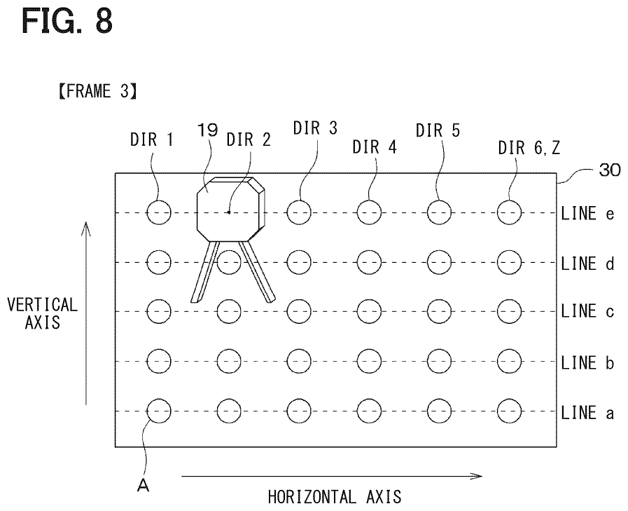

Here, for comparison with the object detection device of the first embodiment, a control process for measurement by an object detection device of a comparative example will be described with reference to the table in FIG. 7 and the explanatory diagram in FIG. 8.

The table in FIG. 7 uses the vertical axis to represent “frames” and the horizontal axis to represent “directions,” with a state in which a beam is output toward each direction in each frame indicated as ON, and a state in which beam output is stopped indicated as OFF. In the comparative example, the ON and OFF states of beam output are controlled by turning the light source ON and OFF. For convenience of explanation, each frame shows the ON and OFF states for only directions 1 to 6 on one line among the plurality of lines.

As shown in FIG. 7, in the comparative example, the object detection device outputs a beam toward directions 1 to 6 and performs measurement during the scanning of frame 1. Next, the object detection device outputs the beam toward directions 1 to 6 and performs measurement during the scanning of frame 2. Here, it is assumed that the object detection device of the comparative example determines that a highly reflective object 19 is present in direction 2 during the scanning of frame 2. Specifically, during the scanning of frame 2, the object detection device of the comparative example is unable to measure the distance to the highly reflective object 19 present in direction 2, because a signal obtained by photoelectrically converting a reflected light from direction 2 exceeds a dynamic range.

Subsequently, the object detection device of the comparative example stops outputting the beam toward direction 2 in the middle of the scanning of frame 3. Specifically, after outputting the beam toward direction 1, the object detection device of the comparative example turns off the light source to stop outputting the beam toward direction 2. Thereafter, for measurements at directions 3 and beyond, the object detection device of the comparative example turns on the light source again, outputs the beam toward directions 3 to 6 to perform measurement. Therefore, as shown in FIG. 8, even during the scanning of frame 3, the object detection device of the comparative example is unable to measure the distance to the highly reflective object 19 present in direction 2. Next, as shown in FIG. 7, it is assumed that the highly reflective object 19 is no longer present in direction 2 due to movement of the vehicle or other factors, and the object detection device of the comparative example outputs the beam toward directions 1 to 6 to perform measurement during the scanning of frame 4.

As described above, after determining the presence of the highly reflective object 19, the object detection device of the comparative example stops outputting the beam toward the direction where the highly reflective object 19 is present in the next frame. Thus, the object detection device of the comparative example cannot measure the distance to the highly reflective object 19. In addition, since the object detection device of the comparative example turns off the light source 1 when stopping the output of the beam, the object detection device of the comparative example needs a recovery time when turning on the light source 1 again.

Compared to the object detection device of the comparative example, the object detection device of the first embodiment has the following configuration and exhibits the following effects. In the object detection device of the first embodiment, when the highly reflective object determiner 4 determines that the signal obtained by photoelectrically converting the reflected light received from a certain direction exceeds the dynamic range of the detector 3, the object detection device performs remeasurement in the certain direction. In the remeasurement, the direction controller 5 and the phase calculator 6 together serve as the remeasurement controller. The optical IC 2 serving as the optical output module outputs the low-intensity beam, whose intensity is reduced by the phase controller 7 serving as the intensity adjuster, toward the certain direction. Accordingly, in the remeasurement, the optical IC 2 outputs the low-intensity beam toward the certain direction to perform the remeasurement. Therefore, during the remeasurement, this prevents the signal obtained by photoelectrically converting the reflected light reflected from the highly reflective object 19 from exceeding the dynamic range of the detector 3. Accordingly, the object detection device of the first embodiment is capable of measuring the distance to the highly reflective object 19. In addition, since this object detection device forms the low-intensity beam using the phase controller 7 with light generated from the identical light source 1, the light source 1 is maintained in the ON state. Since the light source is not turned OFF unlike the comparative example, no recovery time for the light source is required. Accordingly, the object detection device of the first embodiment can improve the measurement rate compared to the comparative example. Furthermore, since the intensity adjuster forms the low-intensity beam using light generated from the identical light source 1, it is not necessary to add a separate light source system or the like. Accordingly, this object detection device can reduce the number of components and cost.

In the first embodiment, in the remeasurement, the phase calculator 6 calculates the intensity of the low-intensity beam so that the signal obtained by photoelectrically converting the reflected light from a certain direction falls within the dynamic range of the detector 3 based on the reflected light received from the present direction in the previous measurement. Accordingly, in the remeasurement, the object detection device can perform distance measurement of the highly reflective object 19 quickly and reliably.

In the first embodiment, in the remeasurement, before the optical IC 2 outputs a beam to the next direction (for example, direction N+1) following a certain direction (for example, direction N) during the scan within an identical frame, the direction controller 5 and the phase calculator 6 control the output so that the low-intensity beam is output toward the certain direction. Accordingly, when the object detection device determines that the highly reflective object 19 is present in a certain direction, the object detection device performs remeasurement in the certain direction before outputting the beam to the next direction. As a result, the distance to the highly reflective object 19 can be measured quickly, thereby improving the measurement rate. Note that, in the present disclosure, the “identical frame” means a frame identical to a frame in which the highly reflective object determiner 4 has determined that the signal obtained by photoelectrically converting the reflected light received from the certain direction exceeds the dynamic range of the detector 3.

In the first embodiment, the light source 1 generates light using the FMCW method. Incidentally, in the FMCW method, if the light source is stopped, it takes time to stabilize the light source before measurement can be restarted, resulting in a significant decrease in the measurement rate. In contrast, in the first embodiment, since the phase controller 7 forms the low-intensity beam using light generated by the identical light source 1, it is not necessary to stop the light source 1. Therefore, the object detection device of the first embodiment can measure the distance to the highly reflective object 19 quickly and improve the measurement rate.

In the first embodiment, the optical IC 2, which serves as the optical output module, is constituted by the OPA 10. When performing remeasurement of distance, the object detection device outputs the low-intensity beam in a certain direction by phase control of the OPA 10. Accordingly, since the OPA 10 can change the output direction of the beam as desired through phase control by the phase adjuster 14, remeasurement can be performed at any desired timing. Therefore, this object detection device can improve the measurement rate. Furthermore, since the phase controller 7 can adjust the intensity reduction amount of the beam by controlling the phase of the OPA 10, there is no need to add any components, and no recovery time is required. Therefore, the object detection device of the first embodiment can improve the measurement rate at low cost.

In the first embodiment, the phase controller 7 can reduce the beam intensity during the remeasurement by diffusing the light, that is, by expanding the area perpendicular to the beam propagation direction to a desired size through the phase control of the OPA 10. Accordingly, there is no need to add any components to change the beam intensity, and no recovery time is required. Therefore, the object detection device of the first embodiment can improve the measurement rate at low cost.

In the first embodiment, in the remeasurement, the phase controller 7 can reduce the beam intensity by diffusing the light, that is, by expanding the area in any direction perpendicular to the beam propagation direction through phase control of the OPA 10. Accordingly, the phase controller 7 can change the shape of the beam in any direction perpendicular to the propagation direction by controlling the phase of the OPA 10.

In the first embodiment, in the remeasurement, the phase controller 7 can adjust the area perpendicular to the beam propagation direction by phase control of the OPA 10, including non-linearization or randomization of the phase shift amount. Accordingly, the phase controller 7 can change the beam intensity as desired through phase control of the OPA 10.

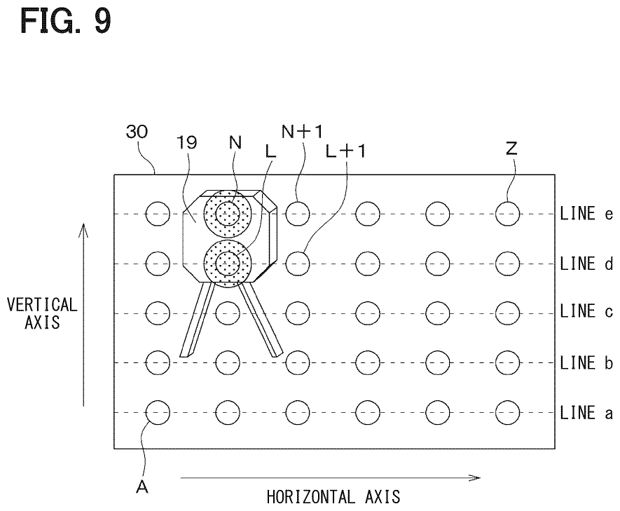

Here, measurement by the object detection device of the first embodiment in the case where the highly reflective object 19 is present across a plurality of directions will be described with reference to FIG. 9.

As shown in FIG. 9, the highly reflective object 19 is present across direction L of line d and direction N of line e within the measurement range 30. In this case, when the object detection device determines that the highly reflective object 19 is present in the measurement of direction L on line d, the object detection device outputs a low-intensity beam to direction L again and performs remeasurement of direction L before proceeding to the measurement of direction L+1. Furthermore, when the object detection device determines that the highly reflective object 19 is present in the measurement of direction N on line e, the object detection device outputs a low-intensity beam to direction N again and performs remeasurement of direction N before proceeding to the measurement of direction N+1. In this manner, even when the highly reflective object 19 is present across a plurality of directions, the object detection device of the first embodiment can quickly perform distance measurement of the highly reflective object 19, thereby improving the measurement rate.

### Second Embodiment

The following describes a second embodiment of the present disclosure. The second embodiment differs from the first embodiment in that a part of a control process for remeasurement of the highly reflective object 19 has been modified, while the other parts are the same as those of the first embodiment. Therefore, only the part that differs from the first embodiment will be described.

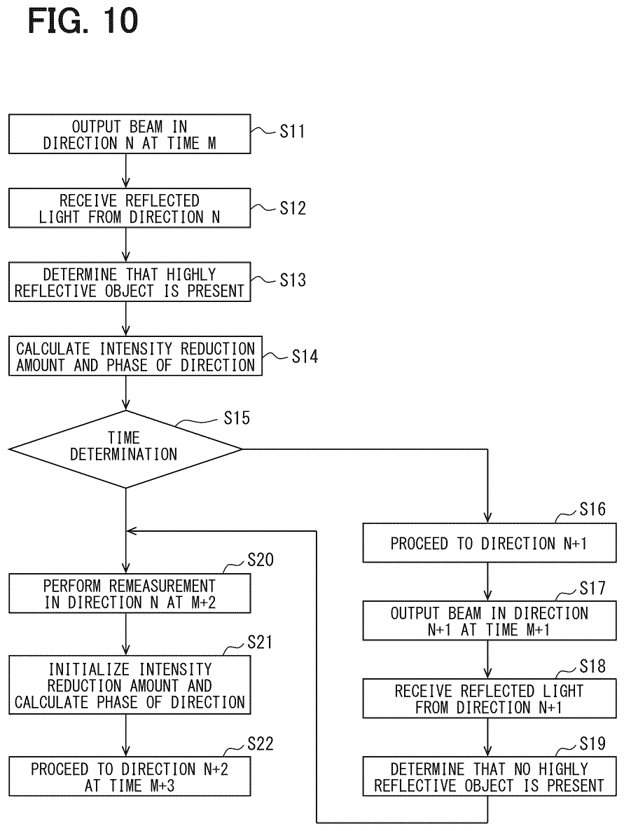

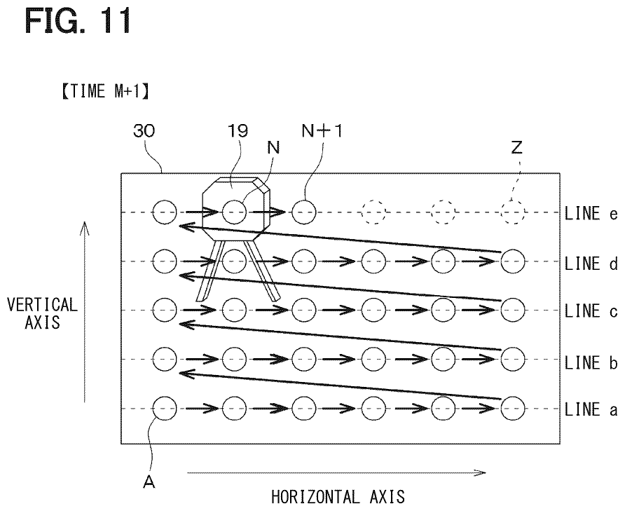

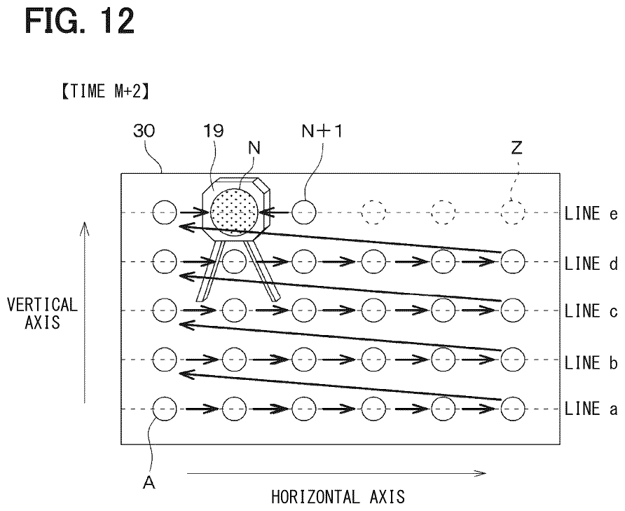

The control process for remeasurement of the highly reflective object 19 by the object detection device of the second embodiment will be described with reference to the flowchart in FIG. 10 and the explanatory diagrams in FIG. 11 and FIG. 12. The flowchart in FIG. 10 illustrates, for example, the control process for measurement from direction N to direction N+2 as shown in FIGS. 11 and 12.

As shown in FIG. 10, in S11, the object detection device outputs a beam toward direction N at time M. In S12, the object detection device receives a reflected light of the beam output at time M and reflected by the highly reflective object 19 present in direction N. Then, in S13, the object detection device determines, by means of the highly reflective object determiner 4, whether the signal obtained by photoelectrically converting the reflected light exceeds the dynamic range of the detector 3. In S13, it is assumed that the highly reflective object 19 is present in direction N, and that it has been determined that the signal obtained by photoelectrically converting the reflected light exceeds the dynamic range of the detector 3.

Then, in S14, the object detection device, by means of the direction controller 5 and the phase calculator 6, calculates the intensity reduction amount for the low-intensity beam to be output in the remeasurement in direction N, as well as the phase of the direction in which the highly reflective object 19 is present. The object detection device detects a time required for the calculation while performing the calculation. In the following description, the calculation of the intensity reduction amount for the low-intensity beam to be output in the remeasurement and the phase calculation for the direction in which the highly reflective object 19 is present are collectively referred to as “remeasurement calculation,” and the time required for this calculation is referred to as the “remeasurement calculation time.”

Furthermore, in S14, while performing the “remeasurement calculation for direction N,” the object detection device makes a time determination in S15. The time determination in S15 determines whether the “remeasurement calculation time for direction N” is longer than the time required for the optical IC 2 to output a beam in the next direction (that is, direction N+1) and for the detector 3 to perform distance measurement of the object 18. In the following description, the time required for the optical IC 2 to output a beam in the next direction and for the detector 3 to perform distance measurement of the object 18 is referred to as the “measurement time for the next direction.”

If, in the time determination of S15, the “remeasurement calculation time for direction N” is shorter than the “measurement time for the next direction N+1,” the object detection device proceeds to S20 and performs the remeasurement in direction N.

On the other hand, if, in the time determination of S15, the “remeasurement calculation time for direction N” is longer than the “measurement time for the next direction N+1”, the object detection device, while performing the “remeasurement calculation for direction N” in S14, transitions the process to S16 and proceeds with the measurement for direction N+1. That is, in S17, the object detection device outputs the beam in direction N+1 at time M+1, and in S18, the object detection device receives the reflected light of the beam output at time M+1 in direction N+1 and reflected by the object 18 present in direction N+1. Then, in S19, the object detection device determines, by means of the highly reflective object determiner 4, whether the signal obtained by photoelectrically converting the reflected light exceeds the dynamic range of the detector 3. In S19, it is assumed that the signal obtained by photoelectrically converting the reflected light is determined to be within the dynamic range of the detector 3. That is, as shown in FIG. 11, it is determined that no highly reflective object 19 is present in direction N+1. Furthermore, it is assumed that, either before or simultaneously with the determination in S19, the calculation for the remeasurement in direction N in S14 has been completed. Then, the object detection device proceeds to S20.

In S20, the object detection device outputs the low-intensity beam toward direction N at time M+2 and performs a remeasurement in direction N. That is, as shown in FIG. 12, the low-intensity beam is output toward the highly reflective object 19 present in direction N. Then, the object detection device receives the reflected light from the low-intensity beam output at time M+2 and reflected in direction N, and performs distance measurement of the highly reflective object 19 present in direction N.

Subsequently, in S21, the object detection device initializes the intensity reduction amount (that is, returns the beam intensity to the intensity of the reference beam) and calculates the direction in which the beam will be output in the next measurement (that is, direction N+2). Then, in S22, the object detection device outputs a beam toward direction N+2 at time M+3 and performs measurement in direction N+2.

The object detection device of the second embodiment described above controls the operation such that, when the “remeasurement calculation time for a certain direction” is longer than the “measurement time for the next direction,” a remeasurement in the certain direction is performed after a measurement in the next direction or subsequent directions has been performed. Accordingly, the object detection device performs measurement in the next direction or subsequent directions while executing the remeasurement calculation for the certain direction, and then performs the remeasurement in the certain direction thereafter. Therefore, the object detection device can effectively utilize the remeasurement calculation time to proceed with the measurement of each direction within the frame, thereby improving the measurement rate.

Incidentally, the object detection device may employ different scanning methods for a plurality of axes that constitute a frame. For example, FIG. 11 and FIG. 12 referenced in the description of the second embodiment show that the horizontal axis employs a scanning method based on phase control of the OPA10, while the vertical axis employs a scanning method based on wavelength control. In this case, the scanning method using phase control of the OPA10 achieves a faster scanning speed than the scanning method using wavelength control. That is, the horizontal axis becomes a fast axis with a higher scanning speed, while the vertical axis becomes a slow axis with a lower scanning speed than the horizontal axis.

Therefore, in the object detection device of the second embodiment, when the “remeasurement calculation time for direction N” is longer than the “measurement time for the next direction N+1,” control is performed so that the remeasurement in direction N is performed within the same scanning line (for example, line e) in which direction N is located. Accordingly, in cases where a frame is formed by the fast axis with a high scanning speed and the slow axis with a low scanning speed, remeasuring the highly reflective object 19 within the fast axis allows the measurement of the highly reflective object 19 to be performed at the highest possible speed. In other words, the delay time required for remeasurement can be minimized.

### Modification of Second Embodiment

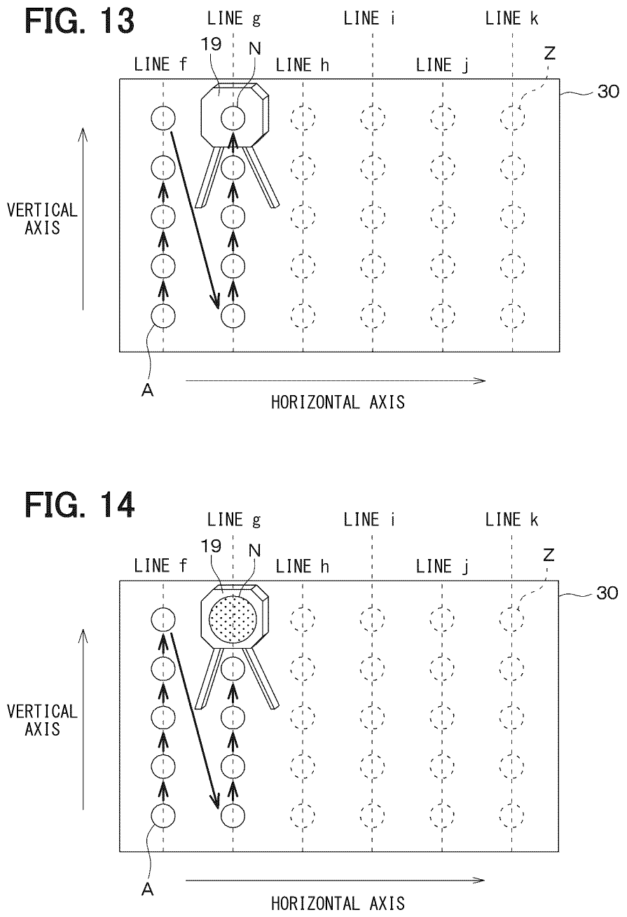

A modification of the second embodiment will be described with reference to FIG. 13 and FIG. 14. In the modification of the second embodiment, the vertical axis employs a scanning method based on phase control of the OPA 10, while the horizontal axis employs a scanning method based on wavelength control. In this case, the vertical axis serves as the fast axis with a higher scanning speed, while the horizontal axis serves as the slow axis with a lower scanning speed than the vertical axis.

Therefore, in the modification of the second embodiment, if the remeasurement calculation time for direction N is longer than the measurement time for the next direction N+1, control is performed so that the remeasurement in direction N is performed within the scanning line (for example, line g) in the direction of the vertical axis where direction N is located. It should be noted that, in FIG. 13 and FIG. 14, since direction N is the last direction on line g, the remeasurement of distance for direction N is performed within line g before proceeding to line h. Accordingly, even in the modification of the second embodiment, by performing the remeasurement of the highly reflective object 19 within the fast axis, the measurement of the highly reflective object 19 can be performed at the highest possible speed. In other words, the delay time required for remeasurement can be minimized.

### Third Embodiment

The following describes a third embodiment of the present disclosure. The third embodiment differs from the first embodiment and the like in that a part of a control process for remeasurement of the highly reflective object 19 has been modified, while the other parts are the same as those of the first embodiment and the like. Therefore, only the part that differs from the first embodiment will be described.

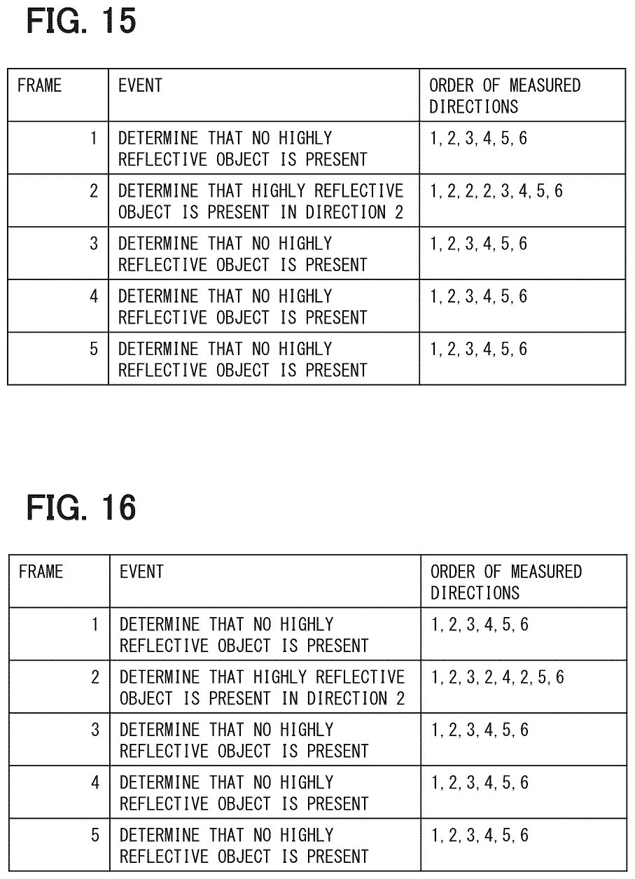

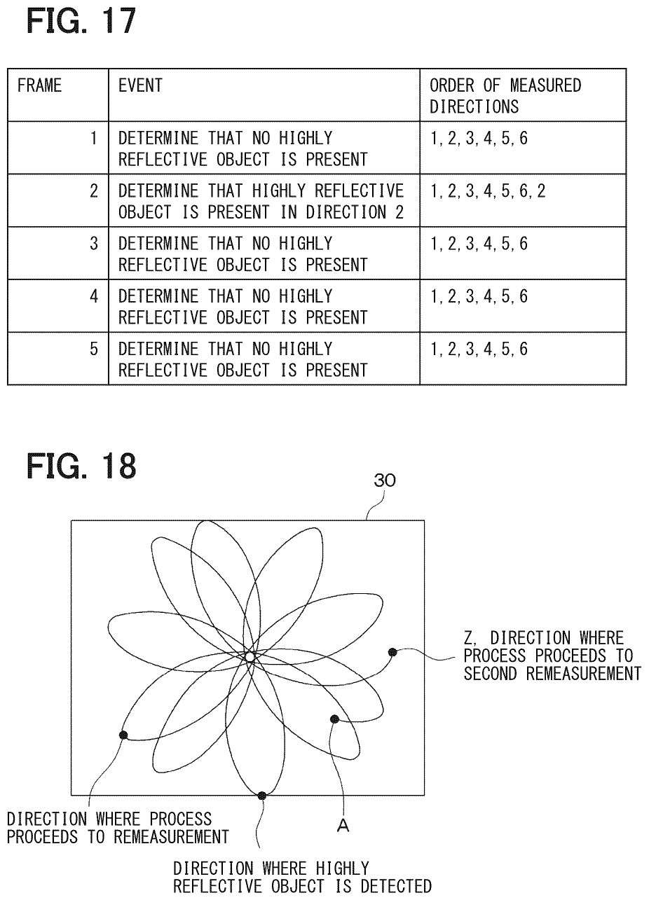

The control process by which the object detection device of the third embodiment performs remeasurement of the highly reflective object 19 will be described with reference to the table in FIG. 15. The table in FIG. 15 shows, with the vertical axis representing “frames” and the horizontal axis representing “events” and “chronological order of the measured directions,” the events and the sequence of directions to be measured in each frame. For the sake of convenience in explanation, only directions 1 to 6 on one line among a plurality of lines are shown for each frame. It should be noted that this also applies to the tables in FIG. 16 and FIG. 17, which will be referenced in the descriptions of the fourth and fifth embodiments described later.

As shown in FIG. 15, the object detection device measures in the order of directions 1 to 6 during the scanning of frame 1. In frame 1, the highly reflective object 19 is not detected.

Next, when the object detection device performs measurement in the order of direction 1 and direction 2 during the scanning of frame 2, the object detection device determines that a highly reflective object 19 is present in direction 2 because the signal obtained by photoelectrically converting the reflected light from direction 2 exceeds the dynamic range. Then, the object detection device calculates the intensity reduction amount and outputs a low-intensity beam to direction 2 to perform remeasurement in direction 2. However, it is assumed that even in this remeasurement (hereinafter, also referred to as a first remeasurement), since the signal obtained by photoelectrically converting the reflected light exceeded the dynamic range, the distance measurement of the highly reflective object 19 present in direction 2 could not be performed. In that case, the object detection device recalculates the intensity reduction amount based on the reflected light received during the first remeasurement, outputs a low-intensity beam to direction 2 again, and performs a second remeasurement in direction 2. If distance measurement of the highly reflective object 19 present in direction 2 can be performed in the second remeasurement, the object detection device performs measurements in directions 3 to 6 in order.

Subsequently, the object detection device performs measurements sequentially from direction 1 to direction 6 during the scanning of frame 3. In frame 3, the highly reflective object 19 is not detected. During the scanning of frame 4, the object detection device performs measurements sequentially from direction 1 to direction 6. In frame 4 as well, the highly reflective object 19 is not detected. During the scanning of frame 5, the object detection device performs measurements sequentially from direction 1 to direction 6. In frame 5 as well, the highly reflective object 19 is not detected.

The object detection device of the third embodiment described above exhibits the following operational effects due to its configuration. In the third embodiment, when the object detection device determines that a highly reflective object 19 is present in a certain direction, the object detection device performs a remeasurement of a distance to the highly reflective object 19 during the scan within the identical frame. Accordingly, since the object detection device performs a remeasurement during the scan within a single frame, the object detection device can measure the distance to the highly reflective object 19 more quickly and improve the measurement rate.

In the third embodiment, when it is determined by the highly reflective object determiner 4 that the signal obtained by photoelectrically converting the reflected light received from a certain direction in the remeasurement exceeds the dynamic range of the detector 3, the object detection device performs a second remeasurement in the certain direction during the scan within the identical frame. Accordingly, even if the distance to the highly reflective object 19 could not be measured during the remeasurement, the object detection device can quickly and reliably measure the distance to the highly reflective object 19 by performing a second remeasurement during the scanning within a single frame.

In the third embodiment, in the second remeasurement, the object detection device calculates the intensity reduction amount (that is, the intensity of the low-intensity beam) such that the signal obtained by photoelectrically converting the reflected light reflected in the certain direction falls within the dynamic range of the detector 3, based on the reflected light received during the remeasurement. Accordingly, in the second remeasurement, the distance to the highly reflective object 19 can be measured quickly and reliably.

### Fourth Embodiment

The following describes a fourth embodiment. The fourth embodiment differs from the second embodiment and the like in that a part of the control process for executing the remeasurement of the highly reflective object 19 has been modified, while the other parts are the same as those of the second embodiment and the like. Therefore, only the part that differs from the second embodiment and the like will be described.

The control process for remeasurement of the highly reflective object 19 by the object detection device of the fourth embodiment will be described with reference to the table in FIG. 16. As shown in FIG. 16, the object detection device performs measurements in the order of direction 1 to direction 6 during the scanning of frame 1. In frame 1, the highly reflective object 19 is not detected.

Next, when the object detection device performs measurement in the order of direction 1 and direction 2 during the scanning of frame 2, the object detection device determines that a highly reflective object 19 is present in direction 2 because the signal obtained by photoelectrically converting the reflected light from direction 2 exceeds the dynamic range. Then, while performing the calculation for the intensity reduction amount and phase for the remeasurement in direction 2 (hereinafter referred to as “remeasurement calculation for direction 2”), the object detection device determines whether the remeasurement calculation time for direction 2 is longer than a time required to perform a measurement in direction 3. If the object detection device determines that the remeasurement calculation time for direction 2 is longer than the time required to perform the measurement in direction 3, the object detection device performs the measurement in direction 3 while executing the remeasurement calculation for direction 2. If the remeasurement calculation for direction 2 is completed before or at the same time as the completion of the measurement in direction 3, the object detection device performs the remeasurement in direction 2. However, it is assumed that, even in this remeasurement, since the signal obtained by photoelectrically converting the reflected light exceeded the dynamic range, the distance measurement of the highly reflective object 19 present in direction 2 could not be performed. In that case, while performing the calculation for the intensity reduction amount and phase for a second remeasurement in direction 2 (hereinafter referred to as “second remeasurement calculation for direction 2”), the object detection device determines whether the calculation time for the second remeasurement in direction 2 is longer than a time required to perform a measurement in direction 4. If the object detection device determines that the calculation time for the second remeasurement in direction 2 is longer than the time required to perform the measurement in direction 4, the object detection device performs the measurement in direction 4 while executing the second remeasurement calculation for direction 2. If the second remeasurement calculation for direction 2 is completed before or at the same time as the completion of the measurement in direction 4, the object detection device performs the second remeasurement in direction 2. If the object detection device can measure the distance to the highly reflective object 19 present in direction 2 in the second remeasurement, the object detection device proceeds to measurements in direction 5 and direction 6 in order.

Subsequently, the object detection device performs measurements sequentially from direction 1 to direction 6 during the scanning of frame 3. In frame 3, the highly reflective object 19 is not detected. During the scanning of frame 4, the object detection device performs measurements sequentially from direction 1 to direction 6. In frame 4 as well, the highly reflective object 19 is not detected. During the scanning of frame 5, the object detection device performs measurements sequentially from direction 1 to direction 6. In frame 5 as well, the highly reflective object 19 is not detected.

The object detection device of the fourth embodiment described above exhibits the following operational effects due to its configuration. In the fourth embodiment, if the object detection device determines that the time required for the intensity reduction amount for remeasurement in a certain direction where the highly reflective object 19 is present and the phase calculation of the certain direction is longer than the time required to perform a measurement in the next direction, the object detection device performs the remeasurement in the certain direction after performing the measurement in the next direction within the identical frame. Accordingly, by effectively utilizing the time required for the intensity reduction amount for remeasurement and the phase calculation for the direction where the highly reflective object 19 is present, the measurement in the next direction within the identical frame can be performed first, and then the remeasurement for the highly reflective object 19 in the certain direction can be performed, thereby improving the measurement rate.

In the fourth embodiment, if the object detection device determines that the time required for the intensity reduction amount and the phase calculation for the direction for a second remeasurement in a certain direction where the highly reflective object 19 is present is longer than the time required to perform a measurement in the next direction, the object detection device performs the second remeasurement in the certain direction after performing the measurement in the next direction within the identical frame. Accordingly, by effectively utilizing the time required for the intensity reduction amount and phase calculation for the second remeasurement in a certain direction where the highly reflective object 19 is present, the measurement of the next direction within the identical frame can be performed first, and then the second remeasurement of the highly reflective object 19 in the certain direction can be carried out, thereby improving the measurement rate.

### Fifth Embodiment

The following describes a fifth embodiment. The fifth embodiment also differs from the second embodiment and the like in that a part of the control process for executing the remeasurement of the highly reflective object 19 has been modified, while the other parts are the same as those of the second embodiment and the like. Therefore, only the part that differs from the second embodiment and the like will be described.

The control process executed by the object detection device of the fifth embodiment for a remeasurement of the highly reflective object 19 will be described with reference to the table in FIG. 17. As shown in FIG. 17, the object detection device performs measurements in the order of direction 1 to direction 6 during the scanning of frame 1. In frame 1, the highly reflective object 19 is not detected.

Next, when the object detection device performs measurements in the order of direction 1 and direction 2 during the scanning of frame 2, the object detection device determines that a highly reflective object 19 is present in direction 2 because the signal obtained by photoelectrically converting the reflected light from direction 2 exceeds the dynamic range. Then, while performing the remeasurement calculation for direction 2, the object detection device determines whether the remeasurement calculation time for direction 2 is longer than a time required to perform measurements in direction 3 and subsequent directions. If the object detection device determines that the remeasurement calculation time for direction 2 is longer than the time required to perform the measurement in direction 3 and subsequent directions, the object detection device performs the measurement in direction 3 and subsequent directions while executing the remeasurement calculation for direction 2. Specifically, the object detection device performs measurements in directions 3 to 6. If the remeasurement calculation for direction 2 is completed before or at the same time as the completion of the measurement in direction 6, the object detection device performs the remeasurement in direction 2. If the object detection device can measure the distance to the highly reflective object 19 present in direction 2 during the remeasurement, the object detection device proceeds to perform a measurement in the next frame.

Subsequently, the object detection device performs measurements sequentially from direction 1 to direction 6 during the scanning of frame 3. In frame 3, the highly reflective object 19 is not detected. During the scanning of frame 4, the object detection device performs measurements sequentially from direction 1 to direction 6. In frame 4 as well, the highly reflective object 19 is not detected. During the scanning of frame 5, the object detection device performs measurements sequentially from direction 1 to direction 6. In frame 5 as well, the highly reflective object 19 is not detected.

The object detection device of the fifth embodiment described above exhibits the following effects due to its configuration. If the object detection device determines that the time required for the intensity reduction amount for a remeasurement in a certain direction where a highly reflective object 19 is present and the phase calculation in the certain direction is longer than a time required to perform measurements in the next direction and subsequent directions, the object detection device performs the remeasurement in the certain direction after performing the measurements in the next direction and subsequent directions within the identical frame. Accordingly, the object detection device can make effective use of the time required for calculating the intensity reduction amount and the phase of the direction for remeasurement in a certain direction where a highly reflective object 19 is present. By performing the measurement of the next and subsequent directions within the identical frame before performing the remeasurement of the highly reflective object 19 in the certain direction, the measurement rate can be improved.

It should be noted that, in the fifth embodiment, when the object detection device determines, during the scanning of frame 2, that a highly reflective object 19 is present in direction 2, the object detection device performs the measurement in directions 3 to 6 within the identical frame and then performs the remeasurement in direction 2. However, the present disclosure is not limited to this configuration. When the object detection device determines, during the scanning of frame 2, that a highly reflective object 19 is present in direction 2, the object detection device may also perform the remeasurement in direction 2 at any timing during the measurements in directions 3 to 6 within the identical frame.

### Sixth to Eighth Embodiments

Sixth to eighth embodiments differ from the first embodiment and the like in that the scanning lines within the frame are changed, and the other configurations are the same as those of the first embodiment and the like. Therefore, only the part that differs from the first embodiment and the like will be described.

FIG. 18 shows a trajectory of movement along which the object detection device of the sixth embodiment outputs beams within one frame. As shown in FIG. 18, the object detection device of the sixth embodiment scans in such a manner as to draw a plurality of elliptical shapes within one frame, from a measurement start direction A to a measurement end direction Z. The plurality of elliptical shapes are arranged such that their major axes are oriented radially.

FIG. 18 illustrates examples of a direction in which the presence of a highly reflective object 19 is determined, a direction in which the object detection device transitions to a remeasurement, and a direction in which the object detection device transitions to a second remeasurement. It should be noted that the object detection device is not limited to the directions illustrated in the FIG. 18. The object detection device can transition to a remeasurement and a second remeasurement at any timing between the direction where the presence of the highly reflective object 19 has been determined and the measurement end direction Z of the frame. Accordingly, the object detection device of the sixth embodiment can also measure the distance to the highly reflective object 19 with a short additional time, thereby improving the measurement rate.

FIG. 19 shows a trajectory of movement along which the object detection device of the seventh embodiment outputs beams within one frame. As shown in FIG. 19, the object detection device of the seventh embodiment scans in such a way as to draw a plurality of sine curves within one frame, from a measurement start direction A to a measurement end direction Z. The plurality of sine curves are arranged with their phases shifted. The object detection device can transition to a remeasurement or a further remeasurement at any timing between the direction where the presence of the highly reflective object 19 has been determined and the measurement end direction Z of the frame. Therefore, the object detection device of the seventh embodiment can also measure the distance to the highly reflective object 19 with a short additional time, thereby improving the measurement rate.

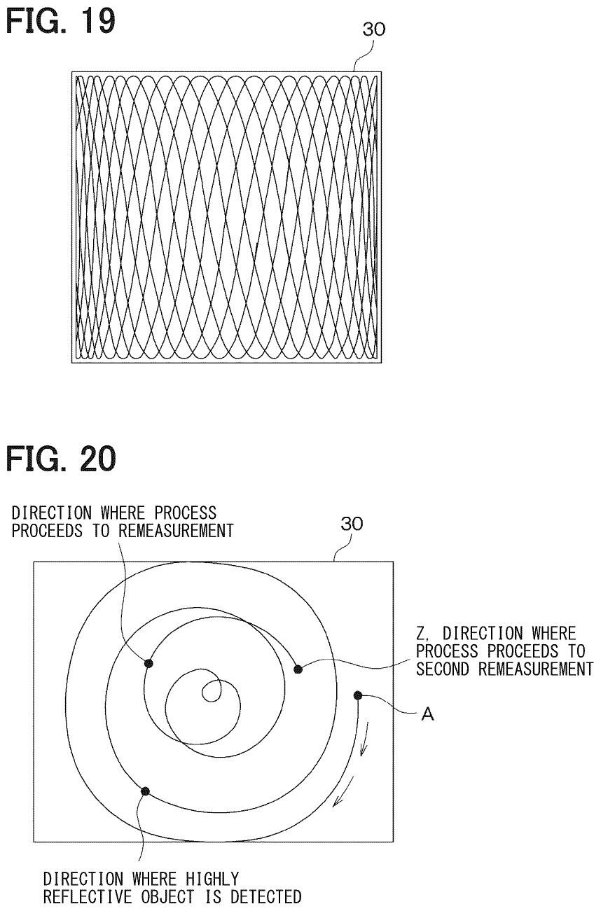

FIG. 20 shows a trajectory of movement along which the object detection device of the eighth embodiment outputs beams within one frame. As shown in FIG. 20, the object detection device of the eighth embodiment scans in such a way as to draw a plurality of circular shapes within one frame, from a measurement start direction A to a measurement end direction Z. The plurality of circular paths are arranged so that each has a different center point, diameter, curvature, and the like. It should be noted that, in the present disclosure, the term “circular shapes” is not limited to a perfect circle but also includes shapes that approximate a circle.

FIG. 20 illustrates examples of a direction in which the presence of a highly reflective object 19 is determined, a direction in which the object detection device transitions to a remeasurement, and a direction in which the object detection device transitions to a second remeasurement. It should be noted that the object detection device is not limited to the directions illustrated in FIG. 20. The object detection device can transition to a remeasurement and a second remeasurement at any timing between the direction where the presence of the highly reflective object 19 has been determined and the measurement end direction Z of the frame. Therefore, the object detection device of the eighth embodiment can also measure the distance to the highly reflective object 19 with a short additional time, thereby improving the measurement rate.

### Other Embodiments

In the above-described embodiments, the light generated by the light source 1 has been described as using the FMCW method. However, the present disclosure is not limited thereto and, for example, may also employ an amplitude-modulated continuous wave (AMCW) method or a pulsed light method. Furthermore, with regard to the measurement method, the present disclosure is not limited to the iToF method, in which a continuous wave is emitted and the distance is calculated based on the phase shift of the reflected light corresponding to the distance to the object 18. The dToF method, in which pulsed laser light is emitted and the distance is calculated based on the time taken for the light to be transmitted and received, may also be employed. It should be noted that iToF stands for Indirect Time of Flight, and dToF stands for Direct Time of Flight.

In the above-described embodiments, the optical IC 2, which constitutes the OPA 10, has been described as being used for the optical output module. However, the optical output module is not limited to this example and may, for example, employ a mechanical method in which the LiDAR main unit is rotated, or a MEMS method in which a beam is scanned using an electromagnetic MEMS mirror. It should be noted that MEMS stands for Micro Electro Mechanical Systems.

The above-described embodiments illustrate examples of the scan transition direction, the measurement start direction A, and the measurement end direction Z within one frame. However, the present disclosure is not limited thereto. For example, in electronic scanning, it is possible to freely change the scan transition direction, such as setting a measurement start direction near the center.

In the above-described embodiments, the object detection devices to be mounted on vehicles have been described. However, the object detection devices are not limited to this application and can be used for various purposes, such as in aircraft, drones, robots, smartphones, and surveying.

The present disclosure is not limited to the embodiments described above, but can be modified appropriately within the scope recited in the claims. The above-described embodiments and a part thereof are not irrelevant to each other, and can be appropriately combined with each other unless the combination is obviously impossible. The constituent element(s) of each of the above embodiments is/are not necessarily essential unless it is specifically stated that the constituent element(s) is/are essential in the above embodiment, or unless the constituent element(s) is/are obviously essential in principle. A quantity, a value, an amount, a range, or the like, if specified in the above-described example embodiments, is not necessarily limited to the specific value, amount, range, or the like unless it is specifically stated that the value, amount, range, or the like is necessarily the specific value, amount, range, or the like, or unless the value, amount, range, or the like is obviously necessary to be the specific value, amount, range, or the like in principle. Further, in each of the above embodiments, when the shape of an element or the positional relationship between elements is mentioned, the present disclosure is not limited to the specific shape or positional relationship unless otherwise particularly specified or unless the present disclosure is limited to the specific shape or positional relationship in principle.

The various controllers 5, 7, the phase calculator 6, and the methods thereof described in the present disclosure are implemented by a dedicated computer provided by configuring a processor and a memory programmed to execute one or more functions embodied by a computer program. Alternatively, the various controllers 5, 7, the phase calculator 6, and the methods described in the present disclosure may be implemented by a special purpose computer configured as a processor with one or more special purpose hardware logic circuits. Alternatively, the various controllers 5, 7, the phase calculator 6, and the methods described in the present disclosure may be implemented by one or more special purpose computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium. The memory is a non-transitory tangible storage medium. When the computer program is executed, a control method corresponding to the computer program is carried out.

What is claimed is:

1. An object detection device configured to detect an object, comprising:
a light source configured to generate a light;
an optical output module configured to output a beam formed from the light generated by the light source to scan a measurement range;
a detector configured to measure a distance to the object using a signal obtained by photoelectrically converting a reflected light that is reflected by the object;
a highly reflective object determiner configured to determine whether the signal obtained by photoelectrically converting the reflected light exceeds a dynamic range of the detector;
an intensity adjuster configured to adjust an intensity of the beam formed from the light generated by the light source; and
a remeasurement controller configured to, when the highly reflective object determiner determines that the signal obtained by photoelectrically converting the reflected light received from a certain direction exceeds the dynamic range of the detector, control the optical output module to output a low-intensity beam, whose intensity has been reduced by the intensity adjuster, toward the certain direction to perform a remeasurement.

2. The object detection device according to claim 1, wherein
the remeasurement controller is further configured to, in the remeasurement, calculate the intensity of the low-intensity beam so that the signal obtained by photoelectrically converting the reflected light from the certain direction falls within the dynamic range of the detector, based on the reflected light received from the certain direction in a previous measurement.

3. The object detection device according to claim 1, wherein
a frame is defined as a single scan by the optical output module from a measurement start direction to a measurement end direction within the measurement range, and
the remeasurement controller is further configured to, in the remeasurement, control the optical output module to output the low-intensity beam toward the certain direction during the scan within an identical frame.

4. The object detection device according to claim 1, wherein
a frame is defined as a single scan by the optical output module from a measurement start direction to a measurement end direction within the measurement range,
the remeasurement is a first remeasurement, and
the remeasurement controller is further configured to, when the highly reflective object determiner determines that the signal obtained by photoelectrically converting the reflected light received from the certain direction in the first remeasurement exceeds the dynamic range of the detector, control the optical output module to output the low-intensity beam toward the certain direction during the scan within an identical frame to perform a second remeasurement.

5. The object detection device according to claim 4, wherein
the remeasurement controller is further configured to, in the second remeasurement, calculate the intensity of the low-intensity beam so that the signal obtained by photoelectrically converting the reflected light reflected from the certain direction falls within the dynamic range of the detector, based on the reflected light received in the first remeasurement.

6. The object detection device according to claim 1, wherein
a frame is defined as a single scan by the optical output module from a measurement start direction to a measurement end direction in the measurement range, and
the remeasurement controller is further configured to, in the remeasurement, control the optical output module to output the low-intensity beam toward the certain direction before the optical output module outputs the beam toward a next direction following the certain direction during the scan within an identical frame.

7. The object detection device according to claim 1, wherein
a frame is defined as a single scan by the optical output module from a measurement start direction to a measurement end direction within the measurement range,
a scan line is defined as a scan by the optical output module in one linear or curved direction during the scan within the frame, and
the remeasurement controller is further configured to, in the remeasurement, when a calculation time required by the remeasurement controller to calculate the intensity of the low-intensity beam so that the signal obtained by photoelectrically converting the reflected light from the certain direction falls within the dynamic range of the detector is longer than a time required for the optical output module to output the beam toward a next direction following the certain direction during the scan within an identical frame and for the detector to measure the distance to the object, control the optical output module to perform the remeasurement by outputting the low-intensity beam toward the certain direction at any timing within the scan line including the certain direction, after performing measurements in the next direction or subsequent directions.

8. The object detection device according to claim 1, wherein
a frame is defined as a single scan by the optical output module from a measurement start direction to a measurement end direction within the measurement range, and
the remeasurement controller is further configured to, in the remeasurement, when a calculation time required by the remeasurement controller to calculate the intensity of the low-intensity beam so that the signal obtained by photoelectrically converting the reflected light from the certain direction falls within the dynamic range of the detector is longer than a time required for the optical output module to output the beam toward a next direction following the certain direction within an identical frame and for the detector to measure the distance to the object, control the optical output module to perform the remeasurement by outputting the low-intensity beam toward the certain direction at any timing within the identical frame, after performing measurements in the next direction or subsequent directions.

9. The object detection device according to claim 1, wherein
the light source is configured to generate the light in a frequency-modulated continuous wave method.

10. The object detection device according to claim 1, wherein
the optical output module includes an optical phased array including:
a plurality of optical waveguides configured to distribute and guide the light generated by the light source;
a plurality of optical antennas disposed at respective ends of the plurality of optical waveguides; and
a phase adjuster configured to perform a phase control of light waves output from the plurality of optical antennas,
the optical phased array is configured to form and scan the beam using the light waves output from the plurality of optical antennas, and
the optical output module is configured to, during the remeasurement, output the low-intensity beam in the certain direction by the phase control of the optical phased array.

11. The object detection device according to claim 10, wherein
the intensity adjuster is further configured to, in the remeasurement, reduce the intensity of the beam by blurring the light through expanding an area perpendicular to a beam propagation direction to a desired size by the phase control of the optical phased array.

12. The object detection device according to claim 10, wherein
the intensity adjuster is further configured to, in the remeasurement, reduce the intensity of the beam by blurring the light through expanding an area perpendicular to a beam propagation direction in any direction perpendicular to the beam propagation direction, by phase control of the optical phased array.

13. The object detection device according to claim 10, wherein
the intensity adjuster is further configured to, in the remeasurement, reduce the intensity of the beam by adjusting an area perpendicular to a beam propagation direction through the phase control of the optical phased array, and
the phase control includes non-linearization or randomization of a phase shift amount.
